(19) United States
(12) Patent Application Publication
(10) Pub. No.: US 2019/0186245 A1
(43) Pub. Date: Jun. 20, 2019

(54) Lubricant Circulating Pump For Electrical Submersible Pump Motor

(71) Applicant: BAKER HUGHES, A GE COMPANY, LLC, Houston, TX (US)

(72) Inventors: Mark L. Bellmyer, Fort Scott, OK (US); Joseph S. Thompson, Owasso, OK (US); David F. McManus, Tulsa, OK (US)

(73) Assignee: BAKER HUGHES, A GE COMPANY, LLC, Houston, TX (US)

(21) Appl. No.: 16/213,701

(22) Filed: Dec. 7, 2018

Related U.S. Application Data
(60) Provisional application No. 62/608,043, filed on Dec. 20, 2017.

(51) Int. Cl. E21B 43/12; F04D 13/10; F04D 29/06; F04D 29/046

(52) U.S. Cl. CPC E21B 43/128; F04D 13/10; F16C 33/1085; F04D 29/046; F04D 29/061

(57) ABSTRACT

An electrical submersible pump assembly includes a motor having a stator with a bore extending along a longitudinal axis. A shaft with axially spaced apart rotor sections extends longitudinally through the bore. At least one lubricant pump is mounted to the shaft within the bore for circulating motor lubricant within the bore. A bearing carrier has an inner diameter in sliding engagement with an outer diameter of the lubricant pump. An anti-rotation member on an outer diameter of the carrier is in engagement with the bore of the stator to prevent rotation of the carrier.

### CROSS-REFERENCE TO RELATED APPLICATION

This application claims priority to provisional application Ser. No. 62/608,043, filed Dec. 20, 2017.

### FIELD OF INVENTION

The present disclosure relates to an electrical submersible pump motor. More particularly, the disclosure relates to a lubricant circulating pump that forms a part of a radial bearing for the motor.

### BACKGROUND

Electrical submersible pumps (ESP) are commonly used to pump well fluid from hydrocarbon producing wells. A typical ESP includes a motor that rotates a shaft to drive a pump. The motor is normally a three-phase electrical motor having a non-rotating stator that has a stator bore. The shaft extends through the stator bore and has rotor sections spaced apart from each other along the length of the shaft. The stator has windings that when powered will interact with the rotor sections to cause rotation of the shaft.

The motors can be 30 feet or more in length. Radial bearings are located in the spaces between the rotor sections to provide radial support for the shaft. The bearings are immersed in a dielectric lubricant in the stator bore for lubrication. The bearings may be of various types and normally include an inner sleeve keyed to the shaft for rotation and a bearing carrier with an outer diameter that fits closely in the stator bore. An anti-rotation member on the outer diameter of the bearing carrier engages the stator bore to prevent rotation of the bearing carrier.

These types of ESPs work well. However, the lubricant in the stator bore can stagnate at and around the radial bearings. Stagnation can cause the temperature of the bearings to rise significantly. The heating will cause the lubricant viscosity to decrease, resulting in localized heating and thermal expansion. The localized heating can accelerate bearing degradation and in severe cases, bearing and motor failure. The heating can cause the rotating sleeve to lock with the non-rotating bearing carrier. Various proposals have been made for lubricant pumps to enhance lubricant circulation in motors.

### SUMMARY

An electrical submersible pump assembly comprises a motor having a stator with a bore extending along a longitudinal axis. A shaft extends longitudinally through the bore. Rotor sections are mounted to the shaft for rotation in unison, the rotor sections being axially spaced apart from each other. At least one lubricant pump within the bore is mounted to the shaft for rotation therewith for circulating motor lubricant within the bore. A bearing carrier has an inner diameter in sliding engagement with an outer diameter of the lubricant pump. An anti-rotation member on an outer diameter of the bearing carrier is in engagement with the bore of the stator to prevent rotation of the bearing carrier.

The lubricant pump may have at least one curved blade. More particularly, the lubricant pump may have a plurality of curved blades spaced around the shaft, defining flow passages between the blades.

In the embodiment shown, the lubricant pump is located between adjacent ones of the rotor sections. The motor may have a plurality of lubricant pumps, each of the lubricant pumps being located in a space between adjacent rotor sections.

In the embodiment shown, the lubricant pump includes an inner sleeve mounted to the shaft for rotation in unison. An outer sleeve surrounds the inner sleeve, the outer sleeve having a greater inner diameter than an outer diameter of the inner sleeve, defining an annular space between. At least one curved blade is within the annular space and joined to the inner diameter of the outer sleeve and the outer diameter of the inner sleeve for rotation in unison with the inner sleeve and the outer sleeve. The inner sleeve, the outer sleeve, and the curved blade may be a monolithic single-piece member.

A port may extend from an inner diameter to the outer diameter of the lubricant pump to divert to the outer diameter of the lubricant pump a portion of the lubricant flowing through the lubricant pump.

### BRIEF DESCRIPTION OF THE DRAWINGS

FIG. 1 is a view of an electrical submersible pump assembly having a motor in accordance with this disclosure.

FIG. 2 is a partial axial sectional view of the motor of FIG. 1.

FIG. 3 is transverse sectional view of the motor of FIG. 2, taken along the line 3-3 of FIG. 2 with the motor housing removed, illustrating a combined lubricant pump and bearing.

FIG. 4 is an enlarged transverse sectional view of a lubricant pump portion of the combined pump and bearing shown in FIG. 3.

FIG. 5 is an axial sectional view of the combined lubricant pump and bearing of FIG. 3, taken along the line 5-5 of FIG. 3 with the adjacent rotor sections removed.

FIG. 6 is an enlarged axial sectional view of the lubricant pump portion of the combined lubricant pump and bearing of FIG. 3.

FIG. 7 is an isometric view of the lubricant pump portion of the combined lubricant pump and bearing of FIG. 3, shown removed from the motor.

### DETAILED DESCRIPTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment, usage of the term “substantially” includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

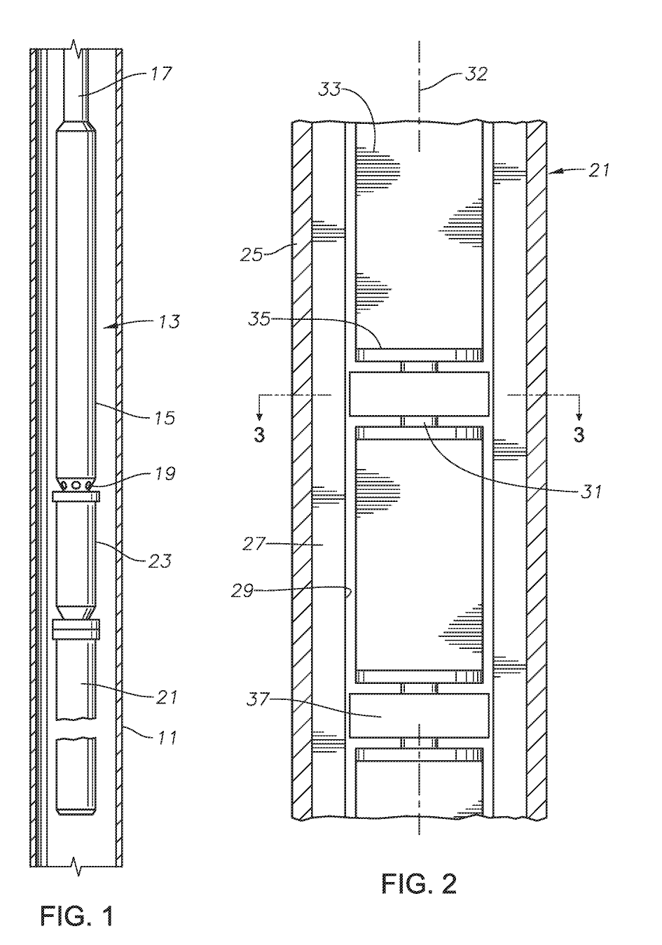

FIG. 1 illustrates a cased well 11 extends downward from a wellhead (not shown). Cased well 11 contains an electrical submersible pump assembly (ESP) 13 for pumping well fluid flowing into cased well 11. ESP 13 has a pump 15 suspended on a string of production tubing 17. Pump 15 may be a centrifugal pump having a large number of stages, each stage having an impeller and a diffuser. Alternately, pump 15 could other types, such as a progressing cavity pump. Pump 15 has a well fluid intake 19 and is driven by a motor 21, normally a three-phase electrical motor.

A seal section 23 connects to motor 21 and has features to reduce a pressure differential between a dielectric lubricant in motor 21 and the hydrostatic pressure of the well fluid. In this example, the pressure equalizing features of seal section 23 locate between motor 21 and pump intake 19, but the pressure equalizing components could be mounted to a lower end of motor 21. ESP 13 may also include other components, such as a gas separator (not shown) and another motor connected in tandem with motor 21. If a gas separator is employed, intake 19 would be at a lower end of the gas separator.

Although FIG. 1 shows ESP 13 oriented vertically, ESP 13 could be within an inclined or horizontal portion of cased well 13. The terms “upper”, “lower” and the like are used only for convenience herein and not in a limiting manner because ESP 13 is not always operated vertically.

FIG. 2 shows more details of motor 21. Motor 21 has a cylindrical housing 25 containing a stator 27. Stator 27 is made up of a large number of thin laminations or disks in a stack in housing 25, the stack being affixed to housing 25 to prevent rotation of stator 27. Each disk has a central opening, defining a bore 29 in stator 27. Electrical motor wire windings (not shown) wind through stator 27. A shaft 31 extends through bore 29 along a longitudinal axis 32.

Shaft 31 extends through a number of rotor sections 33, which connect to shaft 31 with a key and slot arrangement to cause shaft 31 to rotate in unison with rotor sections 33. Each rotor section 33 is made up of a large number of thin laminations or disks. Copper rods (not shown) are spaced around axis 32 parallel to axis 32. The copper rods extend through the laminations of each rotor section 33 to end rings 35 located at the upper and lower ends of each rotor section 33. Rotor sections 33 are axially spaced apart from each other. An electromagnetic field generated by supplying three-phase power to the windings of stator 27 causes rotor sections 33 to rotate shaft 31.

Motor 21 may be lengthy, such as 30 feet or more. A combined radial bearing and lubricant pump 37 locates in at least some of the spaces between adjacent rotor sections 33 provide radial stabilization for shaft 31. A dielectric lubricant fills stator bore 29 and immerses the combined radial bearings and lubricant pumps 37 for lubrication.

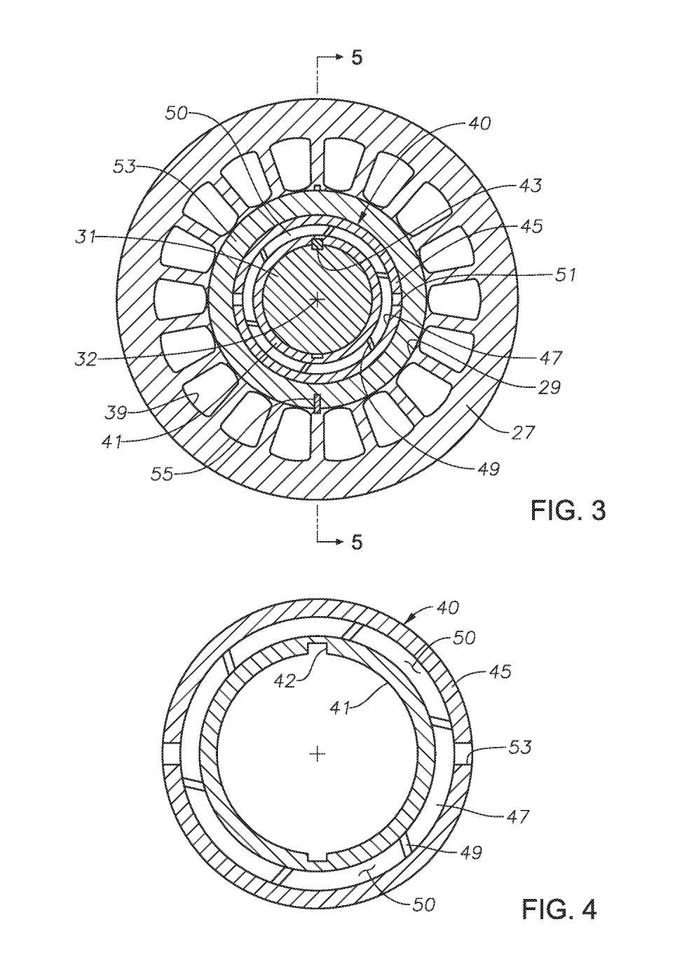

FIG. 3 illustrates stator slots 39 in stator 27 for receiving windings (not shown). FIG. 3 also shows that the lubricant pump 40 of the combined bearing and lubricant pump 37 may comprise an inducer or screw pump 40. Screw pump 40 has a cylindrical inner sleeve 41 having an inner diameter that closely receives shaft 31. Inner sleeve 41 mounts to shaft 31 for rotation in unison, such as by a key 43 that fits in a longitudinally extending slot in shaft 31 and a mating slot 44 (FIG. 4) in the inner diameter of inner sleeve 41. Screw pump 40 also includes a cylindrical outer sleeve 45 that surrounds inner sleeve 41. Outer sleeve 45 has an inner diameter larger than an outer diameter of inner sleeve 41, defining an annular space 47 between them.

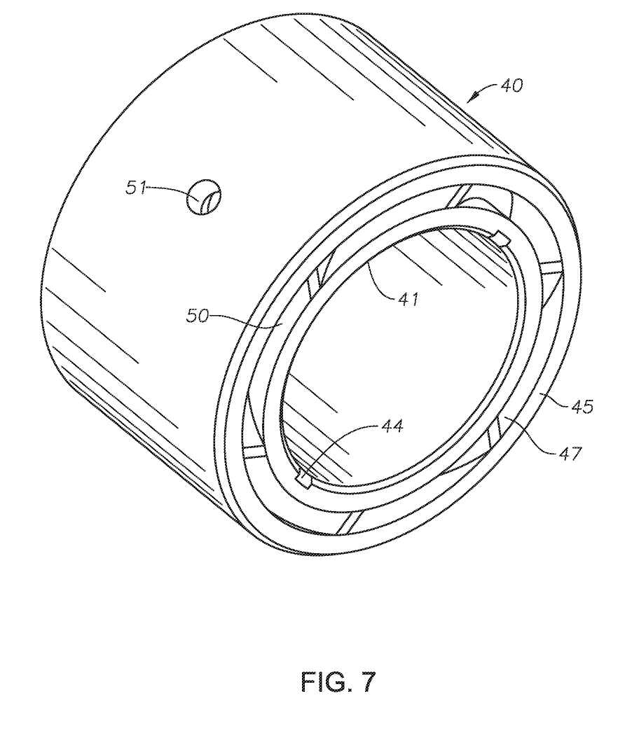

Referring also to FIGS. 4 and 6, annular space 47 of screw pump 40 contains at least one vane or curved blade 49 that has an inner edge joined to the outer diameter of inner sleeve 41 and an outer edge joined to the inner diameter of outer sleeve 45. In the example of FIGS. 3 and 4, there are several blades 49, each extending helically from an open lower end to an open upper of annular space 47 and curving at least partly around the inner sleeve 41. Adjacent ones of the helical blades 49 create helical flow passages 50 between them that extend from the lower to the upper end of the inner and outer sleeves 41, 45. Helical blades 49 are oriented to cause an upward flow of lubricant through flow passage 50 in this example, but the direction of flow alternately could be downward.

Referring also to FIG. 7, at least one port 51 (two shown) extends from the inner diameter to the outer diameter of outer sleeve 45. Each port 51 may be located in a mid-section of outer sleeve 45 between upper and lower ends of screw pump 40. Each port 51 leads from one of the flow passages 50 to the outer diameter of outer sleeve 45. Each port 51 diverts a portion of the lubricant flowing through one of the passage 50 to the outer diameter of outer sleeve 45.

Inner sleeve 41, outer sleeve 45 and helical blades 49 may be integrally formed together as a monolithic single-piece rigid metal structure by additive manufacturing techniques. All of the radial bearings within motor 21 could include one of the screw pumps 40 or only some of them.

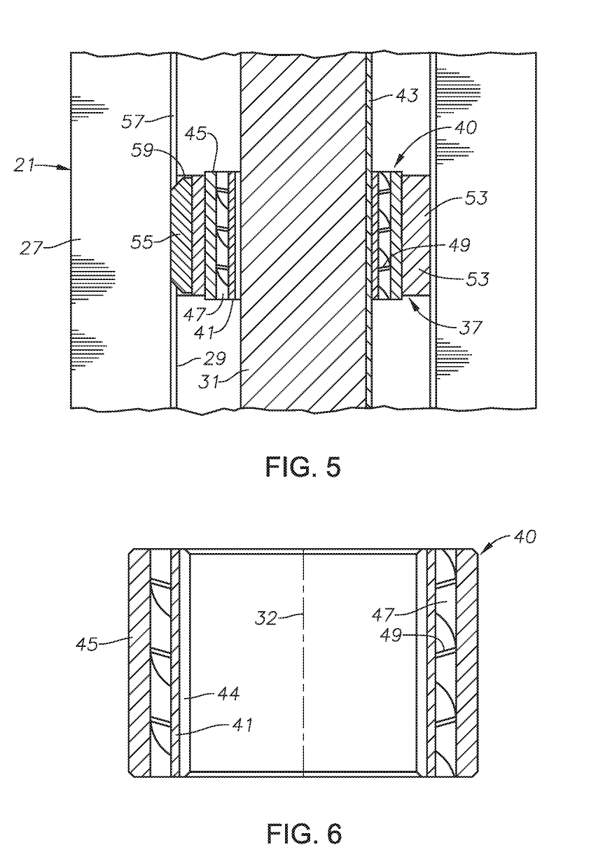

Referring to FIGS. 3 and 5, each combined bearing and lubricant pump 37 also includes a bearing carrier 53. In this example, carrier 53 is a cylindrical member having an inner diameter that closely receives outer sleeve 45 in sliding, rotational engagement. Carrier 53 has an outer diameter that is in close reception with a side wall of stator bore 29. An anti-rotation member prevents carrier 53 from rotating within stator bore 29. In this example, the anti-rotation member comprises a key 55 that fits within mating axially extending slots 57, 59 in the side wall of stator bore 29 and the outer diameter of carrier 53. Alternately, the anti-rotation member could comprise one or more resilient rings encircling the outer diameter of carrier 53 and compressed against the inner diameter or side wall of stator bore 29.

In this example, carrier 53 is a single-piece member. Alternately, carrier 53 could include an insert sleeve between an inner portion of the carrier and the outer sleeve to attenuate vibration being transferred from shaft 31 through combined bearing and lubricant pump 37 to stator 27. Carrier 53 does not need any axial flow passages for lubricant flow because the lubricant flows through flow passages 50 of screw pump 40.

During operation, an electromagnetic interaction of rotor sections 33 with stator 27 causes shaft 31 to rotate. Screw pump 40 rotates with shaft 31, inducing the flow of lubricant from a lower to an upper side of combined bearing and lubricant pump 37, or vice-versa. The combined bearing and lubricant pump 37 provides radial stabilization of shaft 31 through the engagement of carrier 53 with stator bore 29 and the engagement of screw pump 40 with shaft 31. Screw pump 40 and bearing carrier 53 resist any radial movement of shaft 31 by transferring radial forces from shaft 31 to the side wall of stator bore 29. Outer sleeve 45 will perform like a standard bearing sleeve inside bearing carrier 53 with a lubricant wedge supporting it. Ports 51 divert a portion of the lubricant in some of the flow passages 50 to the dynamic interface between outer sleeve 45 and carrier 53. Differences in thermal growth may cause slight axial movement between shaft 31, screw pump 40 and carrier 53.

The circulation of lubricant by screw pump 40 mitigates the occurrence of stagnant lubricant around combined bearing and lubricant pump 37, which otherwise could undergo significant heating and thermal expansion. The present disclosure described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims. For example, the screw pump could be another type, such as an impeller style. Further, instead of the screw pump being integrated into bearing sleeve, it could also be integrated into the rotor end rings.

1. An electrical submersible pump assembly, comprising:
a motor having a stator with a bore extending along a longitudinal axis;
a shaft extending longitudinally through the bore;
rotor sections mounted to the shaft for rotation in unison, the rotor sections being axially spaced apart from each other;
at least one lubricant pump within the bore and mounted to the shaft for rotation therewith for circulating motor lubricant within the bore;
a bearing carrier having an inner diameter in sliding engagement with an outer diameter of the lubricant pump; and
an anti-rotation member on an outer diameter of the bearing carrier and in engagement with the bore of the stator to prevent rotation of the bearing carrier.

2. The assembly according to claim 1, wherein the lubricant pump comprises:
at least one curved blade.

3. The assembly according to claim 1, wherein the lubricant pump comprises:
a plurality of curved blades spaced around the shaft, defining flow passages between the blades.

4. The assembly according to claim 1, wherein the lubricant pump is located between adjacent ones of the rotor sections.

5. The assembly according to claim 1, wherein the at least one lubricant pump comprises a plurality of lubricant pumps, each of the lubricant pumps being located in spaces between adjacent ones of the rotor sections.

6. The assembly according to claim 1, wherein the lubricant pump comprises:
an inner sleeve mounted to the shaft for rotation in unison;
an outer sleeve surrounding the inner sleeve, the outer sleeve having a greater inner diameter than an outer diameter of the inner sleeve, defining an annular space between; and
at least one curved blade within the annular space and joined to the inner diameter of the outer sleeve and the outer diameter of the inner sleeve for rotation in unison with the inner sleeve and the outer sleeve.

7. The assembly according to claim 6, wherein the inner sleeve, the outer sleeve, and the curved blade comprise a monolithic single-piece member.

8. The assembly according to claim 1, further comprising a port extending from an inner diameter to the outer diameter of the lubricant pump to divert to the outer diameter of the lubricant pump a portion of the lubricant flowing through the lubricant pump.

9. An electrical submersible pump assembly, comprising:
a motor having a stator defining a bore extending along a longitudinal axis, the bore being filled with a dielectric lubricant;
a shaft extending longitudinally through the bore;
rotor sections mounted to the shaft for rotation in unison, the rotor sections being axially spaced apart from each other;
at least one combined bearing and lubricant pump, comprising:
an inner sleeve mounted to the shaft for rotation in unison;
an outer sleeve surrounding the inner sleeve, the outer sleeve having a greater inner diameter than an outer diameter of the inner sleeve, defining an annular space between;
at least one curved blade within the annular space and joined to the inner diameter of the outer sleeve and the outer diameter of the inner sleeve for rotation in unison with the inner sleeve and the outer sleeve, the inner and outer sleeves and the blade being immersed in the lubricant within the bore to circulate lubricant within the bore as the shaft rotates;
a bearing carrier having an inner diameter in sliding engagement with an outer diameter of the outer sleeve; and
an anti-rotation member on an outer diameter of the bearing carrier and in engagement with a side wall of the bore of the stator to prevent rotation of the bearing carrier.

10. The assembly according to claim 9, wherein:
said at least one combined bearing and lubricant pump is located adjacent an end of one of the rotor sections.

11. The assembly according to claim 9, wherein:
said at least one combined bearing and lubricant pump is located between two of the rotor sections.

12. The assembly according to claim 9, wherein:
said at least one combined bearing and lubricant pump comprises multiple ones of the combined bearing and lubricant pump, each located between ends of adjacent ones of the rotor sections.

13. The assembly according to claim 9, further comprising a port extending from the inner diameter to the outer diameter of the outer sleeve to divert to the outer diameter of the outer sleeve a portion of the lubricant flowing through the annular clearance.

14. The assembly according to claim 13, wherein the port is located in a mid-section of the outer sleeve between upper and lower ends of the outer sleeve.

15. The assembly according to claim 9, wherein the annular clearance is open at upper ends and lower ends of the inner and outer sleeves.

16. The assembly according to claim 9, wherein the at least one curved blade comprises a plurality of curved blades spaced apart from each other around the annular space.

17. The assembly according to claim 9, wherein the inner sleeve, the outer sleeve and the at least one curved blade comprise a monolithic, single-piece member formed of a metal.

18. An electrical submersible pump assembly, comprising:
a motor having a stator with a bore extending along a longitudinal axis, the bore having an inward facing side wall and being filled with a dielectric lubricant;
a shaft extending longitudinally through the bore;
first and second rotor sections mounted to the shaft for rotation in unison, the first and second rotor sections being axially spaced apart from each other, defining an axial space between the first and second rotor sections;
an inner sleeve mounted to the shaft for rotation in unison in the axial space;
an outer sleeve surrounding the inner sleeve, the outer sleeve having a greater inner diameter than an outer diameter of the inner sleeve, defining an annular space between that is open at a top and a bottom of the inner and outer sleeves;
a plurality of blades within the annular space joined to the inner diameter of the outer sleeve and to the outer diameter of the inner sleeves for rotating the outer sleeve in unison with the inner sleeve, the blades curving at least partly around the inner sleeve, defining helical flow passages between the blades to circulate lubricant within the bore as the shaft rotates;
a bearing carrier having an inner diameter in sliding engagement with an outer diameter of the outer sleeve, the bearing carrier having an outer diameter in close reception with the side wall of the bore to provide radial support to the shaft; and
an anti-rotation member on the outer diameter of the bearing carrier and in engagement with the side wall of the bore of the stator to prevent rotation of the bearing carrier.

19. The assembly according to claim 18, further comprising a port extending from the inner diameter to the outer diameter of the outer sleeve to divert to the outer diameter of the outer sleeve a portion of the lubricant flowing through the flow passages.

20. The assembly according to claim 18, wherein the inner sleeve, the outer sleeve, the blades, and the bearing carrier provide resistance to radial movement of the shaft relative to the side wall of the bore in the axial space.
